(19) United States
(12) Patent Application Publication
(10) Pub. No.: US 2026/0097974 A1
(43) Pub. Date: Apr. 9, 2026

(54) LIQUID PURIFICATION METHOD AND LIQUID PURIFICATION SYSTEM

(71) Applicant: CANON KABUSHIKI KAISHA, Tokyo (JP)

(72) Inventors: IKUO NAKAZAWA, Kanagawa (JP); TAKAHARU AOTANI, Tokyo (JP)

(21) Appl. No.: 19/416,328

(22) Filed: Dec. 11, 2025

Related U.S. Application Data
(63) Continuation of application No. PCT/JP2024/021591, filed on Jun. 14, 2024.

(30) Foreign Application Priority Data
Jun. 26, 2023 (JP) 2023-104197

(51) Int. Cl. C02F 1/36; C02F 1/32; C02F 1/78

(52) U.S. Cl. CPC C02F 1/36; C02F 1/32; C02F 1/78; C02F 2303/26

(57) ABSTRACT

A liquid purification method includes preparing a first container and a to-be-treated liquid in the first container, generating fine liquid droplets of the liquid above a surface of the liquid by oscillating an ultrasonic vibrator disposed in the liquid, and purifying the liquid by bringing the fine liquid droplets into contact with ozone gas.

### CROSS-REFERENCE TO RELATED APPLICATIONS

This application is a Continuation of International Patent Application No. PCT/JP2024/021591, filed Jun. 14, 2024, which claims the benefit of Japanese Patent Application No. 2023-104197, filed Jun. 26, 2023, both of which are hereby incorporated by reference herein in their entirety.

### BACKGROUND

### Field of the Technology

The present disclosure relates to a liquid purification method and a liquid purification system for purifying a to-be-treated liquid.

### Description of the Related Art

Liquid purification methods using ozone gas are utilized in water and sewage treatment facilities. Unlike chemical sterilization, ozone decomposes into oxygen by itself, resulting in no residual substances. Furthermore, since ozone can be generated from atmospheric oxygen or water as raw materials, there are advantages in terms of chemical procurement and management.

Bubbling is employed as a technique for dissolving ozone gas into a liquid. In dissolution by gas bubbling, bubbles rise and diffuse into the gas phase before sufficient ozone is dissolved, resulting in inefficient utilization of ozone gas. In addition, undissolved ozone gas that rises and diffuses into the gas phase cannot be released directly into the atmosphere, necessitating a separate exhaust ozone gas treatment device, which tends to increase costs.

Japanese Patent No. 4259797 describes a technique for effectively utilizing ozone gas by reducing the bubble diameter during bubbling using agitation force from a line mixer, thereby suppressing the rising speed and prolonging the residence time in the liquid.

However, the technique described in Japanese Patent No. 4259797 is directed to generating ozone bubbles in the to-be-treated liquid, and the dissolution efficiency of ozone in the to-be-treated liquid is insufficient, resulting in high costs associated with purifying the to-be-treated liquid.

### SUMMARY

In view of the above issues, the present disclosure is directed to providing a liquid purification method and a liquid purification system that purify a liquid with a high degree of efficiency without incurring significant costs.

According to an aspect of the present disclosure, a liquid purification method includes preparing a first container and a to-be-treated liquid in the first container, generating fine liquid droplets of the liquid above a surface of the liquid by oscillating an ultrasonic vibrator disposed in the liquid, and purifying the liquid by bringing the fine liquid droplets into contact with ozone gas.

Features of the present disclosure will become apparent from the following description of embodiments with reference to the attached drawings.

### BRIEF DESCRIPTION OF THE DRAWINGS

FIG. 1 is a diagram illustrating a configuration of a liquid purification system.

FIG. 2 is a diagram illustrating a liquid purification method in which purified liquid is collected in a second container by the liquid purification system.

FIG. 3 is a diagram illustrating a functional configuration of a liquid purification system equipped with a mercury lamp.

FIG. 4 is a diagram illustrating a functional configuration of a liquid purification system in which a plurality of ultrasonic vibrators is arranged.

FIG. 5 is a diagram illustrating a liquid purification system using a mesh-type ultrasonic vibrator.

FIG. 6 is a diagram illustrating a liquid purification system in which the ultrasonic vibrator is inclined upward.

FIG. 7 is a diagram illustrating a liquid purification system intended for continuous inline operation.

FIG. 8 is a diagram illustrating a liquid purification method at the liquid surface by the liquid purification system.

FIG. 9 is a diagram illustrating a liquid purification system using a double-structured container.

### DESCRIPTION OF THE EMBODIMENTS

Embodiments of the present disclosure will be described below. The following embodiments are provided by way of example and are not intended to unduly limit the spirit of the present disclosure. In this specification, fine liquid droplets refer to droplets having a diameter of 1 mm or less. Preferably, the number average particle size of the fine liquid droplets is 0.99 mm or less.

A liquid purification system and a liquid purification method using the liquid purification system according to the present embodiment will be described below with reference to the drawings.

### First Embodiment

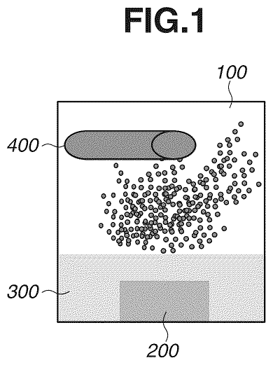

FIG. 1 illustrates an example of a functional configuration of a liquid purification system 100. The liquid purification system 100 includes a first container, an ultrasonic vibrator 200 disposed in a to-be-treated liquid 300 prepared in the first container, and an ozone gas generation unit 400 for generating ozone in the first container.

In the liquid purification system 100 according to the present embodiment, the liquid is prepared in the first container, and fine liquid droplets are generated above the liquid surface by oscillating the ultrasonic vibrator 200 disposed in the liquid. Here, the inside of the first container is filled with ozone gas by the ozone gas generation unit 400, and the fine liquid droplets generated by the ultrasonic vibrator 200 come into contact with ozone, thereby purifying the liquid. The generation of mist-like fine liquid droplets by the ultrasonic vibrator 200 ensures a sufficient floating time in the ozone-filled space, and since the volume per droplet is large, the to-be-treated liquid can be efficiently purified. Note that the liquid purification systems described in this embodiment and other embodiments are merely examples of configurations, and it is also within the scope of the present disclosure to appropriately combine the respective configurations.

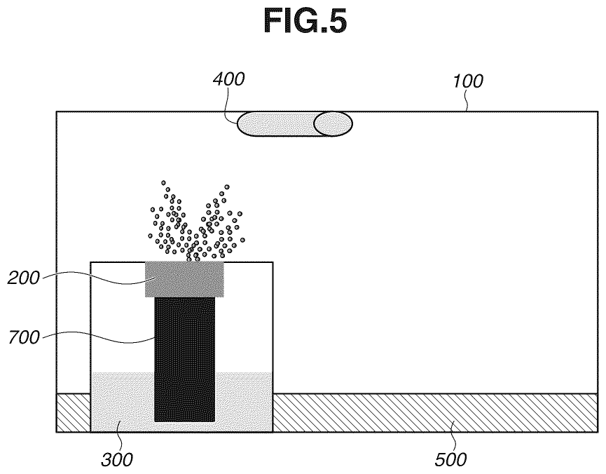

The ultrasonic vibrator 200 used in the present embodiment is not particularly limited, but a device used for piezoelectric atomization is a desirable form. Piezoelectric atomization devices are broadly classified into an immersion type, in which the device is installed in the liquid to atomize the liquid near the gas-liquid interface as shown in FIG. 1, and a mesh type, in which piezoelectric elements are arranged around a mesh plate to supply fine liquid through mesh holes, as will be described below with reference to FIG. 5. In the liquid purification system 100, the immersion type is more desirable because it does not pose a risk of clogging.

In the present disclosure, the liquid purification system 100 is characterized in that fine liquid droplets are supplied above the liquid surface of the to-be-treated liquid by the ultrasonic vibrator 200. This functional configuration is effective for ensuring a contact time between the fine liquid droplets and ozone in the mist state. Furthermore, the fine liquid droplets generated by the ultrasonic vibrator 200 can be mist-sized droplets.

By generating mist-sized fine liquid droplets with the ultrasonic vibrator 200 included in the liquid purification system 100 of the present disclosure, it is possible for the droplets to float for a long time in the gas phase containing ozone, and the ratio of the gas-liquid interface per droplet volume can be increased. As a result, ozone gas can be efficiently dissolved and utilized.

Examples of ozone gas generation methods by the ozone gas generation unit 400 include irradiating oxygen with a low-pressure mercury lamp, and an electric discharge method and water electrolysis. The ozone generation method is not particularly limited, but ozone generation by Xe excimer lamp irradiation, which reacts only with oxygen in the air to generate ozone, can be employed. Of course, any gas containing oxygen may be used, and pure oxygen may also be used.

Further, fine bubbles can be included in the fine liquid droplets. Fine bubbles refer to small bubbles having a size of less than 100 μm containing gas. It has been reported that including fine bubbles causes the effect of ozone water to prolong, and this can be adopted in the present disclosure. In particular, ultra-fine bubbles with a diameter of 1 μm or less can be used because they do not rise in the liquid.

As for the position of the immersion-type ultrasonic vibrator used as the ultrasonic vibrator 200, the thickness from the ultrasonic vibrator to the liquid surface can be 15 cm or less. If the thickness is greater than this, there is concern that the efficiency of fine liquid droplet generation will decrease.

Furthermore, the particle size distribution of fine bubbles having a size of 20 μm or less generated by the ultrasonic vibrator 200 can be 5 or less. If the distribution is greater than this, the rising speed of the bubbles increases, which may hinder efficient utilization of ozone. The particle size distribution is defined as the ratio of the volume average particle diameter (dw) to the number average particle diameter (dn) (dw/dn).

Furthermore, the average relative humidity of the environment in which ozone is brought into contact can be 90% or higher. If the humidity is low, the fine liquid droplets may vaporize, resulting in insufficient purification. For example, in the case of colorants, it is expected that decolorization is more facilitated when the colorant is dissolved at the molecular level than in the solid state.

In the first embodiment, the liquid purification system 100 returns the purified liquid to the to-be-treated liquid 300 and repeats the purification process, thereby diluting and clarifying the to-be-treated liquid.

### Second Embodiment

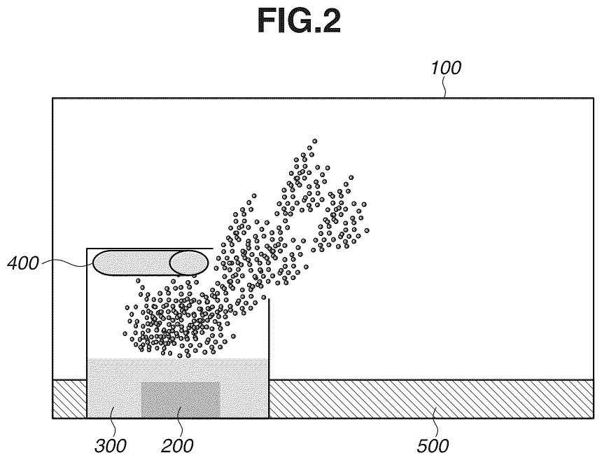

The first embodiment has been described of a liquid purification system that purifies liquid by returning the purified liquid to the to-be-treated liquid. The liquid purification system 100 of the present embodiment will be described with reference to FIG. 2.

The liquid purification system 100 of the present embodiment further includes a second container for collecting droplets that have come into contact with ozone, in addition to the first container for storing the to-be-treated liquid 300. As in the first embodiment, the liquid purification system 100 includes an ultrasonic vibrator 200 disposed in the liquid stored in the first container and an ozone gas generation unit 400 for generating ozone gas in the first container. The liquid is purified by atomizing the liquid into fine droplets by ultrasonic vibration and bringing the fine droplets into contact with ozone gas.

By collecting the purified liquid in the second container with this configuration, it is possible to achieve highly efficient purification and collection of the purified liquid.

### Modification Example 1

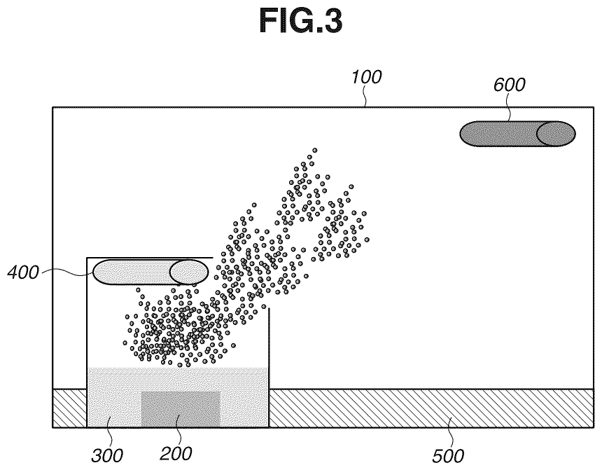

Modification Example 1 will be described with reference to FIG. 3. In Modification Example 1, the liquid purification system 100 further includes an ultraviolet light 600 for generating ultraviolet rays.

The wavelength of the ultraviolet light 600 may include 254 nm, which is absorbed by ozone. By irradiating ozone with ultraviolet rays from the ultraviolet light 600, ozone generated by the ozone gas generation unit 400 transforms into hydroxyl radicals. In this state, promoted oxidation functions during the purification process, and when the inside of the liquid purification system 100 is opened to the outside air, ozone inside the system can be deactivated, which is a useful form. Of course, when quenching ozone in the collection mechanism after the purification process, known methods, such as using manganese-based catalysts or activated carbon, may be used. That is, the liquid purification system 100 described in this modification example includes a step of irradiating ozone with ultraviolet rays as a post-process of the purification step by the ultraviolet light 600.

### Modification Example 2

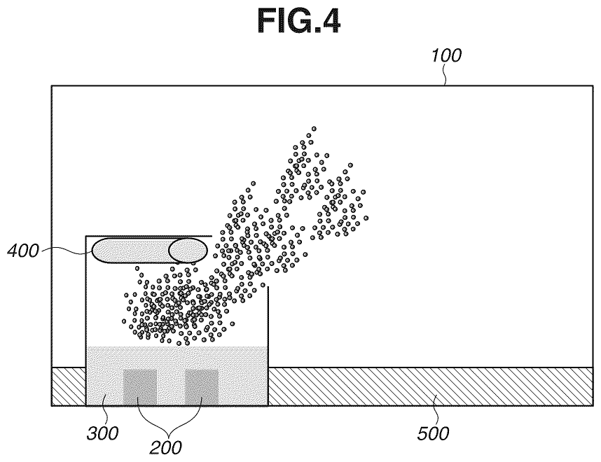

Modification Example 2 will be described with reference to FIG. 4. The liquid purification system 100 of Modification Example 2 is characterized by including a plurality of ultrasonic vibrators 200. Due to the plurality of ultrasonic vibrators 200, the generation speed of fine liquid droplets from the to-be-treated liquid is increased, and the purification speed is improved.

### Modification Example 3

Modification Example 3 will be described with reference to FIG. 5. In FIG. 5, the ultrasonic vibrator 200 is a mesh-type ultrasonic vibrator 200, and fine liquid droplets can be generated from mesh holes by arranging piezoelectric elements around the mesh plate. In a case where the ultrasonic vibrator 200 is of the mesh type, the liquid purification system 100 further includes a supply unit 700 for supplying the to-be-treated liquid 300 stored in the first container to the ultrasonic vibrator 200.

### Modification Example 4

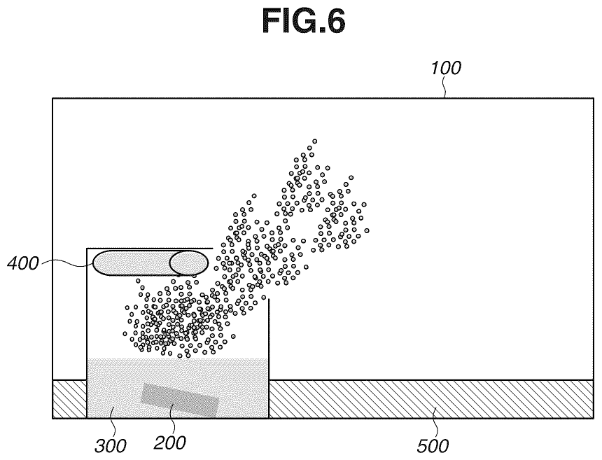

Modification Example 4 will be described with reference to FIG. 6. FIG. 6 illustrates a liquid purification system 100 in which a ultrasonic vibrator 200 is inclined toward the opening of the first container. In the liquid purification system 100, by arranging the ultrasonic vibrator inclined toward the opening of the first container, the generated droplets can be collected with a high degree of efficiency. [Modification Example 5]

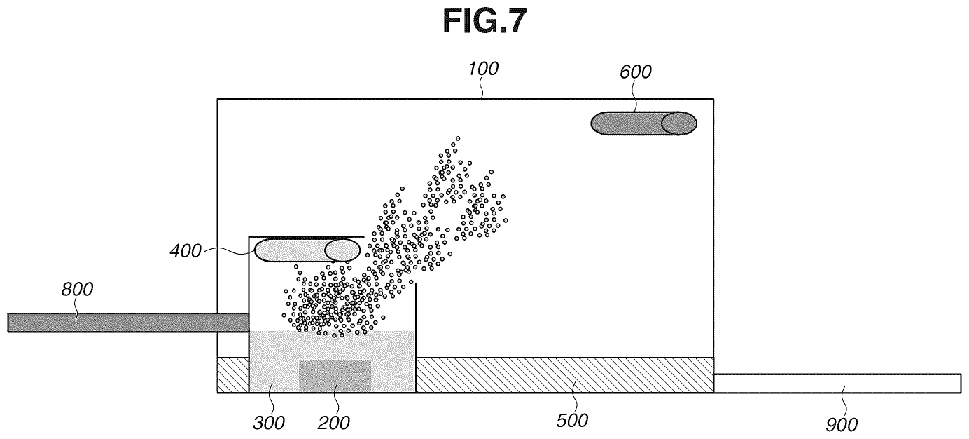

Modification Example 5 will be described with reference to FIG. 7. In this modification example, the liquid purification system 100 further includes a supply passage 800 for supplying untreated liquid to the first container and a discharge passage 900 for discharging purified liquid collected in the second container. With this configuration, it is possible to continuously supply the to-be-treated liquid and discharge the treated liquid, enabling the liquid purification system 100 to operate for a long time and efficiently purify a large amount of liquid.

### Modification Example 6

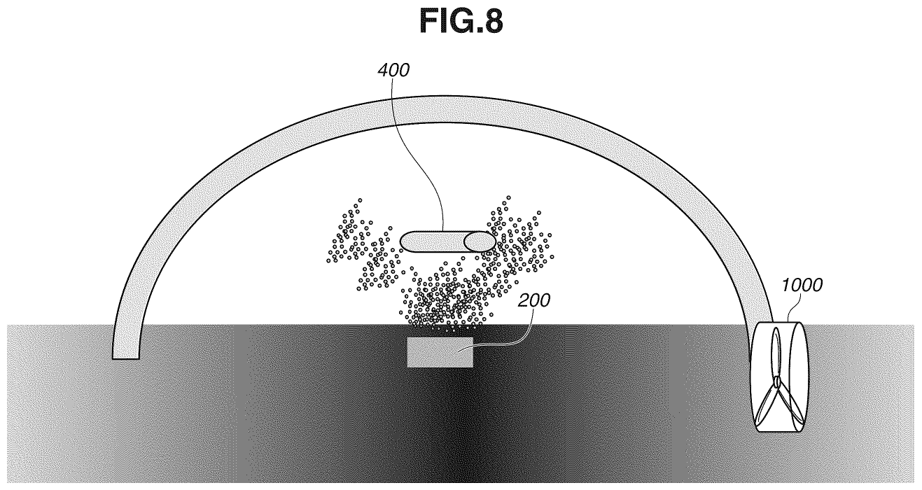

Modification Example 6 will be described with reference to FIG. 8. FIG. 8 illustrates a configuration in which a liquid purification system is installed on the liquid surface of a to-be-treated liquid, such as a pond, lake, sea, and liquid in a reservoir such as a pool, to purify the liquid. In this modification example, the liquid purification system includes a collection container for collecting discrete fine liquid droplets and a stirring mechanism 1000 for stirring the liquid. The liquid purification system may be installed floating on the to-be-treated liquid, or may be moved over the liquid surface to purify the liquid.

### Modification Example 7

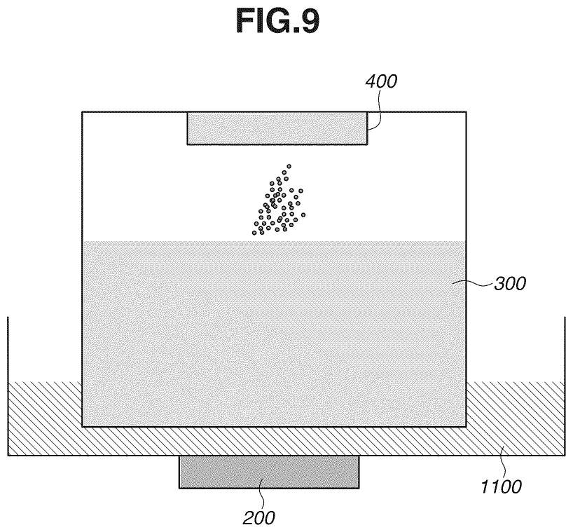

Modification Example 7 will be described with reference to FIG. 9. In Modification Example 7, a liquid purification system includes a first container for storing a to-be-treated liquid and a liquid tank 1100 provided outside the first container, thereby providing a configuration in which the to-be-treated liquid is purified without directly contacting the ultrasonic vibrator 200. The ultrasonic vibrator 200 may be provided on the back side of the first container.

Various conditions for the liquid purification method using the liquid purification system 100 were verified focusing on the following items, and the results will be described as examples. The droplet diameter was measured using water-sensitive paper. Specifically, the droplet diameter was calculated from the volume obtained by using water-sensitive paper.

The cumulative concentration of fine bubbles having a size of 20 μm or less (hundreds of millions per mL), the diameter of ultra-fine bubble particles having a size of 20 μm or less (nm), the percentage of the number of ultra-fine bubbles in fine bubbles having a size of 20 μm or less, and the particle size distribution of ultra-fine bubbles having a size of 20 μm or less were all measured using a Shimadzu Corporation measuring instrument (model SALD-7500nano).

Relative humidity was measured using a temperature and humidity data logger manufactured by Fujita Electric Works, Ltd (model KT-255F).

Sterilization was measured using a bio-checker manufactured by SAN-AI-OBBLI Co, Ltd. (product number TTC).

Odor determination was made using a gas detection tube for ammonia manufactured by GASTEC CORPORATION. (product number 3HM).

The effect on the to-be-treated liquid was evaluated based on the criteria described below using the following before-and-after-treatment evaluation items (some items were not evaluated).

For evaluation of decolorization, if the liquid has a characteristic of absorption in the wavelength range of 300 nm to 800 nm, regardless of whether the liquid is chromatic or achromatic, there is room for improvement in transparency in the liquid. In particular, in colorant manufacturing sites where decolorization is required, production is carried out for each color to avoid mixing. For yellow colorants (for example, DY132), it is necessary to treat wastewater having a characteristic of absorption around slightly above 300 nm, and for blue colorants (for example, AB9), it is necessary to treat wastewater having a characteristic of absorption around slightly below 800 nm.

Decolorization: Reduction percentage of absorbance at 640 nm in Blue No. 1 aqueous solution
A Less than 10%
B 10% or more, less than 50%
C 50% or more, less than 80%
D 80% or more
   Deodorization: Reduction percentage of ammonia odor measured by the gas detection tube
A Less than 10%
B 10% or more, less than 50%
C 50% or more, less than 80%
D 80% or more
   Sterilization: Reduction percentage of colony count of E. coli (JM109)
A Less than 10%
B 10% or more, less than 50%
C 50% or more, less than 80%
D 80% or more
   Decomposition: Reduction percentage of peak area in liquid chromatography using PEG200 aqueous solution
A Less than 10%
B 10% or more, less than 50%
C 50% or more, less than 80%
D 80% or more
   Ozone gas utilization efficiency: Percentage of ozone concentration in the space where droplets are in contact to ozone concentration in the surrounding external environment
A Less than 10%
B 10% or more, less than 50%
C 50% or more, less than 80%
D 80% or more
   Productivity: Relative percentage of liquid treatment amount per hour in Example 4 in the normal upward direction
A 99% or more
B 80% or more, less than 99%
C 50% or more, less than 80%
D Less than 50%

### Example 1

With reference to FIG. 1, a piezoelectric atomization element (1.6 MHz) manufactured by SEIKO GIKEN INC. was used as the ultrasonic vibrator 200. The ultrasonic vibrator 200 was installed at the bottom of a 500 mL glass container (first container), the top portion was sealed, and 200 mL of the to-be-treated liquid 300 was poured. The installation position of the ultrasonic vibrator 200 was adjusted so that the distance between the gas-liquid interface and the piezoelectric element surface was 2 cm, and the liquid purification process was performed. A Xe excimer lamp (manufactured by Oak Seisakusho, model SE172-035HEC1) was used as the ozone gas generation unit 400.

The average diameter of droplets generated by the ultrasonic vibrator was 20 μm.

### Example 2

A mesh-type ultrasonic vibrator 200 and a diffuser (model GXZ-J626) manufactured by KMJ as the first container were provided, and 200 mL of the liquid 300 to be treated was used. Except for referring to the liquid purification system 100 shown in FIG. 5, purification was performed in a similar manner as in Example 1.

The average diameter of droplets generated by the ultrasonic vibrator was 5 μm.

### Example 3

Except for providing an immersion-type ultrasonic atomization unit (IMA-SG1 (IM1-24 hood)) manufactured by SEIKO GIKEN INC. above the installation position of the ultrasonic vibrator 200, the liquid purification process was performed in a similar manner as in Example 1.

The average diameter of droplets generated by the ultrasonic atomization unit was 5 μm.

### Example 4

Except for pouring 300 mL of the to-be-treated liquid 300 and adjusting the installation position of the ultrasonic vibrator 200 so that the distance between the gas-liquid interface and the piezoelectric element surface was 3 cm, the purification process was performed in a similar manner as in Example 1.

The average diameter of droplets generated by the ultrasonic vibrator 200 was 20 μm.

### Example 5

With reference to FIG. 6, except for tilting the ultrasonic vibrator 200 in the liquid by 5°, the liquid purification process was performed in a similar manner as in Example 4.

The average diameter of droplets generated by the ultrasonic vibrator 200 was 18 μm.

### Example 6

With reference to FIG. 6, except for tilting the ultrasonic vibrator 200 in the liquid by 45°, the purification process was performed in a similar manner as in Example 4.

The average diameter of droplets generated by the ultrasonic vibrator 200 was 18 μm.

### Example 7

With reference to FIG. 6, except for tilting the ultrasonic vibrator 200 in the liquid by 60°, the purification process was performed in a similar manner as in Example 4.

The average diameter of droplets generated by the ultrasonic vibrator 200 was 18 μm.

### Example 8

Except for changing the ozone generation by the ozone gas generation unit 400 from the Xe excimer lamp to a low-pressure mercury lamp (manufactured by Sankyo Denki Co., Ltd, model GLK8MQ-ZH), the liquid purification process was performed in a similar manner as in Example 4.

The average diameter of droplets generated by the ultrasonic vibrator 200 was 20 μm.

### Example 9

Except for changing the ozone generation by the ozone gas generation unit 400 from the Xe excimer lamp to a discharge-type ozone gas generation unit (product name O3 PREMIμM, manufactured by Growth, model AL-11ES3), the purification process was performed in a similar manner as in Example 4.

The average diameter of droplets generated by the ultrasonic vibrator 200 was 20 μm.

### Example 10

Except for pouring 350 mL of the to-be-treated liquid 300 and adjusting the installation position of the ultrasonic vibrator 200 so that the distance between the gas-liquid interface and the piezoelectric element surface was 4 cm, the liquid purification process was performed in a similar manner as in Example 1.

The average diameter of droplets generated by the ultrasonic vibrator 200 was 20 μm.

### Example 11

A 1 L glass container (first container) was used, the top portion was sealed, and 700 mL of the to-be-treated liquid 300 was poured. Except for adjusting the installation position of the ultrasonic vibrator 200 so that the distance between the gas-liquid interface and the piezoelectric element surface was 15 cm, the liquid purification process was performed in a similar manner as in Example 4.

The average diameter of droplets generated by the ultrasonic vibrator 200 was 20 μm.

### Example 12

A 1 L glass container (first container) was used, the top portion was sealed, and 800 mL of the to-be-treated liquid 300 was poured. Except for adjusting the installation position of the ultrasonic vibrator 200 so that the distance between the gas-liquid interface and the piezoelectric element surface was 16 cm, the liquid purification process was performed in a similar manner as in Example 4.

The average diameter of droplets generated by the ultrasonic vibrator 200 was 20 μm.

### Example 13

A 1 L glass container (first container) was used, the top portion was sealed, and 800 mL of the to-be-treated liquid 300 was poured. Except for adjusting the installation position of the ultrasonic vibrator 200 so that the distance between the gas-liquid interface and the piezoelectric element surface was 7 cm, the liquid purification process was performed in a similar manner as in Example 4.

The average diameter of droplets generated by the ultrasonic vibrator 200 was 20 μm.

### Example 14

A 1 L glass container (first container) was used, the top portion was sealed, and 800 mL of the to-be-treated liquid 300 was poured. Except for adjusting the installation position of the ultrasonic vibrator 200 so that the distance between the gas-liquid interface and the piezoelectric element surface was 8 cm, the liquid purification process was performed in a similar manner as in Example 4.

The average diameter of droplets generated by the ultrasonic vibrator 200 was 20 μm.

### Example 15

The liquid purification system shown in FIG. 8 was manufactured as follows. A hemispherical Perfluoroalkoxy (PFA) cover with a capacity of 2 L was used as the fine liquid droplet collection container, and a Tamiya underwater motor (ITEM70154) was used as the screw (propulsion mechanism/liquid stirring mechanism). The ultrasonic vibrator and the ozone gas generation unit were implemented in a similar manner as in Example 1. The liquid purification system was floated on 50 L of 100 ppm Blue No. 1 aqueous solution, and the installation position of the ultrasonic vibrator 200 was adjusted so that the distance between the gas-liquid interface and the piezoelectric element surface was 3 cm, and purification was performed.

The average diameter of droplets generated by the ultrasonic vibrator 200 was 20 μm.

### Example 16

With reference to FIG. 2, a 500 mL glass container was used as the first container, and a 20 L fluorovinyl resin Tedlar bag was installed as the second container in a sealed manner. 300 mL of the to-be-treated liquid 300 was poured into the glass container, and except for adjusting the installation position of the ultrasonic vibrator 200 so that the distance between the gas-liquid interface and the piezoelectric element surface was 8 cm, the liquid purification process was performed in a similar manner as in Example 4.

The average diameter of droplets generated by the ultrasonic vibrator 200 was 6 μm.

### Example 17

In a similar manner as in Example 4, the liquid purification process was performed by controlling driving of the ultrasonic vibrator 200 so that the average relative humidity was 90%.

### Example 18

In a similar manner as in Example 4, the liquid purification process was performed by controlling driving of the ultrasonic vibrator 200 so that the average relative humidity was less than 90%.

### Example 19

With reference to FIG. 5, an ultraviolet light was provided, and except for this, purification was performed in a similar manner as in Example 16.

A low-pressure mercury lamp (manufactured by Sankyo Denki Co., Ltd., model GLK8MQ) was used.

Decolorization reaction was accelerated by ultraviolet irradiation with the ultraviolet light 600. Measurement of the gas concentration in the space inside the liquid purification system after the ultraviolet irradiation revealed that ozone was not detected.

### Comparative Example 1

The to-be-treated liquid was supplied with a water pump, and a shower head (manufactured by Tanaka Kinzoku Seisakusho Co., Ltd., Bollina Pulito) was provided on the waste liquid side, and the ozone gas generation unit 400 was provided in a 20 L fluorovinyl resin Tedlar bag, into which the liquid was sprayed.

The average diameter of droplets generated by the shower head was 2 mm.

### Comparative Example 2

With reference to FIG. 6, except for tilting the ultrasonic vibrator 200 in the liquid by 90°, the liquid purification process was performed in a similar manner as in Example 4. As a result, fine liquid droplets were not generated, and it was not possible to collect treated liquid in the second container.

### Comparative Example 3

Except for changing the shower head to a JSA022 shower head manufactured by Takagi Co., Ltd., purification was performed in a similar manner as in Comparative Example 1.

The average diameter of droplets generated by the shower head was 5 mm.

### Comparative Example 4

With reference to FIG. 6, except for tilting the ultrasonic vibrator 200 in the liquid downward by 180°, purification was performed in a similar manner as in Example 4. As a result, fine liquid droplets were not generated, and it was not possible to collect treated liquid in the second container.

### Comparative Example 5

Except for not driving the ozone gas generation unit 400, purification was performed in a similar manner as in Example 4.

The average diameter of droplets was 20 μm.

### Comparative Example 6

A Xe excimer lamp was provided in a 20 L polyvinylidene fluoride Tedlar bag, and a PFA tube was provided in the bag. One end of the tube was connected to an air pump, and bubbling was performed in the to-be-treated liquid.

Ozone odor spread from the to-be-treated liquid.

Tables 1 and 2 summarize the treatment conditions and effects of the above examples and comparative examples.

TABLE 1
Treatment Conditions

| | Cumulative FB | UFB | Percentage of | | Average |
|---|---|---|---|---|---|
| | ≤20 μm | Diameter | UFB in FB | UFB Size | Relative |
| | (count/mL) | (nm) | (%) | Distribution | Humidity (%) |
| Example 1 | Not evaluated | Not evaluated | Not evaluated | Not evaluated | Not evaluated |
| Example 2 | 8E+09 | 110 | 99 | 4.2 | Not evaluated |
| Example 3 | Not evaluated | Not evaluated | Not evaluated | Not evaluated | Not evaluated |
| Example 4 | 5E+09 | 115 | 99 | 3.8 | 97 |
| Example 5 | 6E+09 | 115 | 99 | 3.5 | 98 |
| Example 6 | 7E+08 | 115 | 99 | 4.2 | 98 |
| Example 7 | 2E+08 | 120 | 99 | 4.6 | 98 |
| Example 8 | 5E+09 | 115 | 99 | 3.8 | 98 |
| Example 9 | 1E+08 | 115 | 99 | 4.3 | 97 |
| Example 10 | 1E+08 | Not evaluated | Not evaluated | Not evaluated | Not evaluated |
| Example 11 | 4E+08 | 115 | 99 | Not evaluated | Not evaluated |
| Example 12 | 3E+08 | 115 | 98 | Not evaluated | Not evaluated |
| Example 13 | 4E+09 | 115 | 98 | 5 | Not evaluated |
| Example 14 | 3E+08 | 120 | 98 | 5.2 | Not evaluated |
| Example 15 | Not evaluated | Not evaluated | Not evaluated | Not evaluated | Not evaluated |
| Example 16 | Not evaluated | Not evaluated | Not evaluated | Not evaluated | Not evaluated |
| Example 17 | Not evaluated | Not evaluated | Not evaluated | Not evaluated | 90 |
| Example 18 | Not evaluated | Not evaluated | Not evaluated | Not evaluated | 89 |
| Example 19 | Not evaluated | Not evaluated | Not evaluated | Not evaluated | Not evaluated |
| Comparative | 3E+07 | 175 | 98 | 5.4 | Not evaluated |
| example 1 | | | | | |
| Comparative | Not evaluated | Not evaluated | Not evaluated | Not evaluated | Not evaluated |
| example 2 | | | | | |
| Comparative | No emission | None | Not evaluated | Not evaluated | Not evaluated |
| example 3 | line | | | | |
| Comparative | Not evaluated | Not evaluated | Not evaluated | Not evaluated | Not evaluated |
| example 4 | | | | | |
| Comparative | 5E+09 | 115 | 99 | 3.8 | 197 |
| example 5 | | | | | |
| Comparative | Not evaluated | Not evaluated | Not evaluated | Not evaluated | Not evaluated |
| example 6 | | | | | |

TABLE 2
Effects

| | Decolorization | Deodorization | Sterilization | Decomposition | Productivity |
|---|---|---|---|---|---|
| Example 1 | A | A | A | A | A |
| Example 2 | A | Not evaluated | B | Not evaluated | Not evaluated |
| Example 3 | A | A | A | A | A |
| Example 4 | A | A | A | A | A |
| Example 5 | A | Not evaluated | A | Not evaluated | A |
| Example 6 | A | Not evaluated | A | Not evaluated | A |
| Example 7 | A | Not evaluated | A | Not evaluated | B |
| Example 8 | B | Not evaluated | A | Not evaluated | A |
| Example 9 | B | Not evaluated | B | Not evaluated | A |
| Example 10 | Not evaluated | Not evaluated | A | Not evaluated | A |
| Example 11 | Not evaluated | Not evaluated | A | Not evaluated | B |
| Example 12 | Not evaluated | Not evaluated | B | Not evaluated | B |
| Example 13 | Not evaluated | Not evaluated | A | Not evaluated | A |
| Example 14 | Not evaluated | Not evaluated | B | Not evaluated | A |
| Example 15 | A | Not evaluated | Not evaluated | Not evaluated | Not evaluated |
| Example 16 | A | A | A | A | B |
| Example 17 | Not evaluated | Not evaluated | A | Not evaluated | A |
| Example 18 | Not evaluated | Not evaluated | B | Not evaluated | B |
| Example 19 | A | A | A | A | A |
| Comparative | D | D | D | Not evaluated | Not |
| example 1 | | | | | evaluated |
| Comparative | Not evaluated | Not evaluated | Not evaluated | Not evaluated | D |
| example 2 | | | | | |
| Comparative | C | D | D | Not evaluated | Not evaluated |
| example 3 | | | | | |
| Comparative | C | Not evaluated | Not evaluated | Not evaluated | Not evaluated |
| example 4 | | | | | |
| Comparative | D | D | D | D | A |
| example 5 | | | | | |
| Comparative | C | Not evaluated | C | C | Not evaluated |
| example 6 | | | | | |

The present disclosure is not limited to the above embodiments, and various changes and modifications can be made without departing from the spirit and scope of the present disclosure. Accordingly, the following claims are attached to make the scope of the present disclosure public.

According to the present disclosure, it is possible to provide a liquid purification method and a liquid purification system that purify a to-be-treated liquid with a high degree of efficiency without incurring significant costs.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A liquid purification method comprising:
preparing a first container and a to-be-treated liquid in the first container;
generating fine liquid droplets of the liquid above a surface of the liquid by oscillating an ultrasonic vibrator disposed in the liquid; and
purifying the liquid by bringing the fine liquid droplets into contact with ozone gas.

2. The liquid purification method according to claim 1, wherein, in the generating, the fine liquid droplets are generated as mist and the fine liquid droplets are brought into contact with the ozone gas.

3. The liquid purification method according to claim 1, wherein the fine liquid droplets contain fine bubbles having a size of 20 μm or less.

4. The liquid purification method according to claim 3, wherein the fine bubbles include ultra-fine bubbles having a size of 1 μm or less.

5. The liquid purification method according to claim 4, wherein a percentage of the number of the ultra-fine bubbles relative to the number of the fine bubbles having a size of 20 μm or less is 99% or more.

6. The liquid purification method according to claim 1, wherein a thickness from the ultrasonic vibrator to the surface of the liquid in the generating is 15 cm or less.

7. The liquid purification method according to claim 4, wherein a ratio of a volume average particle diameter (dw) to a number average particle diameter (dn) (dw/dn) of the ultra-fine bubbles having a size of 20 μm or less is 5 or less.

8. The liquid purification method according to claim 1, further comprising collecting, in a second container, the liquid purified in the purification.

9. The liquid purification method according to claim 1, further comprising irradiating with ultraviolet rays as a post-process of the purification.

10. The liquid purification method according to claim 1, wherein the purification is performed in an environment with an average relative humidity of 90% or more.

11. The liquid purification method according to claim 1, wherein the to-be-treated liquid has a characteristic of absorption in a wavelength range of 300 nm to 800 nm.

12. A liquid purification system comprising:
a first container configured to store a to-be-treated liquid therein;
an ultrasonic vibrator disposed in the liquid stored in the first container; and
an ozone gas generation unit configured to generate ozone in the first container,
wherein the liquid is purified by atomizing the liquid into fine liquid droplets by ultrasonic vibration of the ultrasonic vibrator and bringing the fine liquid droplets into contact with the ozone gas to purify the liquid.

13. A liquid purification system comprising:
an ultrasonic vibrator disposed in a to-be-treated liquid;
an ozone gas generation unit configured to generate ozone gas; and
a collection container configured to cover at least a part of the to-be-treated liquid,
wherein the liquid is purified by atomizing the liquid into fine liquid droplets by ultrasonic vibration of the ultrasonic vibrator and bringing the fine liquid droplets into contact with the ozone gas inside the collection container.

14. The liquid purification system according to claim 13, wherein the to-be-treated liquid is any one of sea water, lake water, pond water, and liquid in a reservoir.

15. The liquid purification system according to claim 13, further comprising a stirring mechanism configured to stir the to-be-treated liquid, wherein the to-be-treated liquid is stirred by the stirring mechanism.
